(19) United States
(12) Patent Application Publication
(10) Pub. No.: US 2007/0298752 A1
(43) Pub. Date: Dec. 27, 2007

(54) RECEIVER AND TRANSMITTING AND RECEIVING SYSTEM

(75) Inventor: Akira NAKADA, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/765,667

(22) Filed: Jun. 20, 2007

(30) Foreign Application Priority Data
Jun. 21, 2006 (JP) 2006-171360

(51) Int. Cl. H04B 1/16; H04B 1/38

(52) U.S. Cl. 455/343.1; 455/572

(57) ABSTRACT

A receiver coupled with a transmitter, the transmitter having a first mode in which a first signal including a first voltage and a reference voltage is output to at least one signal line and a second mode in which the at least one signal line is maintained at the reference voltage, via the at least one signal line according to one aspect of the invention includes: a power supply outputting a second voltage; a voltage conversion circuit converting the second voltage output from the power supply into the first voltage to output; and a receiving circuit coupled with the at least one single line. In the receiver, the first voltage output from the voltage conversion circuit is input into the receiving circuit as a driving voltage in a case where the transmitter is in the first mode; an operation of the voltage conversion circuit is stopped in a case where the transmitter is in the second mode; and in a transition process from the second mode to the first mode, in a case where the transmitter shifts a voltage of the at least one signal line from the reference voltage to the first voltage, the second voltage is input into the receiving circuit as the driving voltage.

The entire disclosure of Japanese Patent Application No. 2006-171360, filed Jun. 21, 2006 is expressly incorporated by reference herein.

### BACKGROUND

1. Technical Field

The present invention relates to a receiver and a transmitting and receiving system. More particularly, the invention relates to a receiver and a transmitting and receiving system including a voltage conversion circuit that converts a power supply voltage being supplied, into a driving voltage operating a receiving circuit.

2. Related Art

In a receiver included in a transmitting and receiving system for digital data, a power supply voltage being supplied is sometimes different from a driving voltage operating a receiving circuit. For example, a power supply voltage being supplied is matched with a voltage of a device coupled to the receiver, and on the other hand, the driving voltage of the receiving circuit is matched with a voltage of a reception signal determined by specifications. Examples of the device coupled to the receiving circuit include a control logic of the receiving circuit and an arithmetic logic which processes digital data received by the receiving circuit. In this case, the receiver includes the voltage conversion circuit such as a step-down DC/DC converter converting the power supply voltage into the driving voltage of the receiving circuit.

Here, the transmitting and receiving system has a technique providing an operation mode and a sleep mode as described in JP-A-2004-274264, JP-A-2000-196694, JP-A-2001-222249, and JP-A-2005-260360, for example. In the operation mode, a signal which transmits digital data, a control command, or the like is transmitted, and in the sleep mode, such significant signal is not transmitted to turn off a main power of the receiver or a transmitter. Thus, the transmitting and receiving system realizes power-saving. In the above technique, a receiver is provided with a signal-monitoring unit driven by a sub-power supply. When the signal-monitoring unit detects a signal transmitted, the signal-monitoring unit supplies a main power to the receiver so as to recover the receiver from the sleep mode to the operation mode.

Here, when being used for an interface between a display and a control device in a cellular phone, for example, low power consumption and downsizing have been requested in the receiver and the transmitting and receiving system including the voltage conversion circuit.

### SUMMARY

An advantage of the present invention is to provide downsizing and low electric power consumption in a receiver and a transmitting and receiving system including a voltage conversion circuit.

According to a first aspect of the invention, a receiver is coupled to a transmitter, the transmitter having a first mode in which a first signal including a first voltage and a reference voltage is output to at least one signal line and a second mode in which the at least one signal line is maintained at the reference voltage, via the at least one signal line. The receiver includes: a power supply outputting a second voltage; a voltage conversion circuit converting the second voltage output from the power supply into the first voltage to output; and a receiving circuit coupled with the at least one single line. In the receiver of the aspect, the first voltage output from the voltage conversion circuit is input into the receiving circuit as a driving voltage in a case where the transmitter is in the first mode; an operation of the voltage conversion circuit is stopped in a case where the transmitter is in the second mode; and in a transition process from the second mode to the first mode, in a case where the transmitter shifts a voltage of the at least one signal line from the reference voltage to the first voltage, the second voltage is input into the receiving circuit as the driving voltage.

In the receiver of the first aspect, the operation of the voltage conversion circuit is stopped in the second mode, being able to restrain the electric power consumption. Further, in the transition process from the second mode to the first mode, the second voltage is input into the receiving circuit as the driving voltage, so that the mode transition of the receiver from the second mode to the first mode can be detected by the receiving circuit. Therefore, it is not necessary to provide a specific circuit for detecting the transition of the transmitter from the second mode to the first mode. Thus, the receiver realizing its miniaturization and low electric power consumption can be obtained.

According to a second aspect of the invention, a receiver is coupled to a transmitter, the transmitter having a first mode in which a first signal including a first voltage and a reference voltage is output to at least one signal line and a second mode in which the at least one signal line is maintained at the reference voltage, via the at least one signal line. The receiver includes: a power supply outputting a second voltage; a voltage conversion circuit; a receiving circuit; and a voltage control circuit. The voltage conversion circuit converts the second voltage output from the power supply into the first voltage to output. The receiving circuit is coupled with the at least one signal line, and is substantively free from electric power consumption thereof in a case where the signal line is maintained at the reference voltage and in a case where the signal line is maintained at a driving voltage being input. The voltage control circuit inputs the first voltage output from the voltage conversion circuit to the receiving circuit as the driving voltage in a case where the transmitter is in the first mode. The voltage control circuit inputs the second voltage output from the power supply to the receiving circuit as the driving voltage while stopping an operation of the voltage conversion circuit in a case where the transmitter is in the second mode.

In the receiver of the second aspect, the operation of the voltage conversion circuit is stopped in the second mode, being able to restrain the electric power consumption. Further, the second voltage is input into the receiving circuit as the driving voltage in the second mode, so that the mode transition of the transmitter from the first mode to the second mode can be detected by the receiving circuit. Therefore, it is not necessary to provide a specific circuit for detecting the transition of the transmitter from the first mode to the second mode. Thus, the receiver realizing its miniaturization and low electric power consumption can be obtained.

In the receiver of the aspect, the receiving circuit may include an inverter circuit operated by the driving voltage and the reference voltage, in its input stage coupled to the at least one single line.

In the receiver of the aspect, the voltage control circuit may include a determination circuit determining whether the transmitter is in the first mode or the second mode based on an output from the receiving circuit; and a switching circuit switching a voltage, controlled by the determination circuit and input into the receiving circuit as the driving voltage, to the first voltage output from the voltage conversion circuit and the second voltage output from the power supply. The function of the voltage control circuit can be realized by determining the mode of the transmitter and controlling the switching circuit based on the output from the receiving circuit.

In the receiver of the aspect, the voltage conversion circuit may be a step-down circuit outputting the first voltage being lower than the second voltage, and may be a step-up circuit outputting the first voltage being higher than the second voltage.

The receiver according to the aspect may further include: at least one other receiving circuit receiving a different signal from the transmitter via a signal line different from the at least one signal line. The voltage control circuit may input the first voltage output from the voltage conversion circuit to the at least one other receiving circuit as the driving voltage in a case where the transmitter is in the first mode, and may stop an operation of the at least one other receiving circuit in a case where the transmitter is in the second mode. Thus, the operation of the other receiving circuit is stopped in a case where the transmitter is in the second mode, so that the other receiving circuit can restrain its electric power consumption.

The receiver of the aspect may further include: a differential receiving circuit receiving a differential signal via two signal lines. In the receiver, the at least one signal line is out of the two signal lines; the first signal transmitted in the first mode is a single end signal transmitted via at least one signal line out of the two signal lines; and the transmitter further has a third mode in which the differential signal is transmitted at high speed via the two signal lines. Thus, the receiver can receive both of the differential signal and the single end signal.

Here, the present invention can be realized in further various aspects. One of further aspects of the invention is a device provided with the receiver of the previous aspects and a display device driving a display by using image data received by the receiver. Another of further aspects of the present invention is a transmitting and receiving system provided with the transmitter and the receiver described above.

### BRIEF DESCRIPTION OF THE DRAWINGS

The invention will be described with reference to the accompanying drawings, wherein like numbers reference like elements.

FIG. 1 is a rough construction diagram of a digital device of an embodiment.

FIG. 2 is an explanatory diagram showing an inner structure of a transmitter.

FIG. 3 is an explanatory diagram showing an inner structure of a data transmission circuit.

FIG. 4 is an explanatory diagram showing a state transition of the data transmission circuit.

FIG. 5 is a schematic view explaining a differential signal and a single end signal.

FIG. 6 is a timing chart showing a voltage of a signal line in a single end transmission mode and a sleep mode.

FIG. 7 is an explanatory diagram showing an inner structure of a receiver.

FIG. 8 is an explanatory diagram showing an inner structure of a terminating circuit.

FIG. 9 is an explanatory diagram showing an inner structure of a data receiving circuit.

FIG. 10 is an explanatory diagram illustrating a switching circuit.

FIGS. 11A and 11B are explanatory diagrams explaining an input stage of a single end receiving circuit.

FIG. 12 is an explanatory diagram showing a state transition of the data receiving circuit and a clock receiving circuit.

FIG. 13 is a timing chart showing a voltage of a signal line, and a driving voltage of the single end signal-receiving unit, in a single end reception mode and a sleep mode.

FIG. 14 is an explanatory diagram showing an inner structure of a receiver of a first modification.

FIG. 15 is an explanatory diagram showing an inner structure of another data reception part.

### DESCRIPTION OF EXEMPLARY EMBODIMENT

Hereinafter, an embodiment will be described with reference to the accompanying drawings.

### Embodiment

Structure of Digital Device

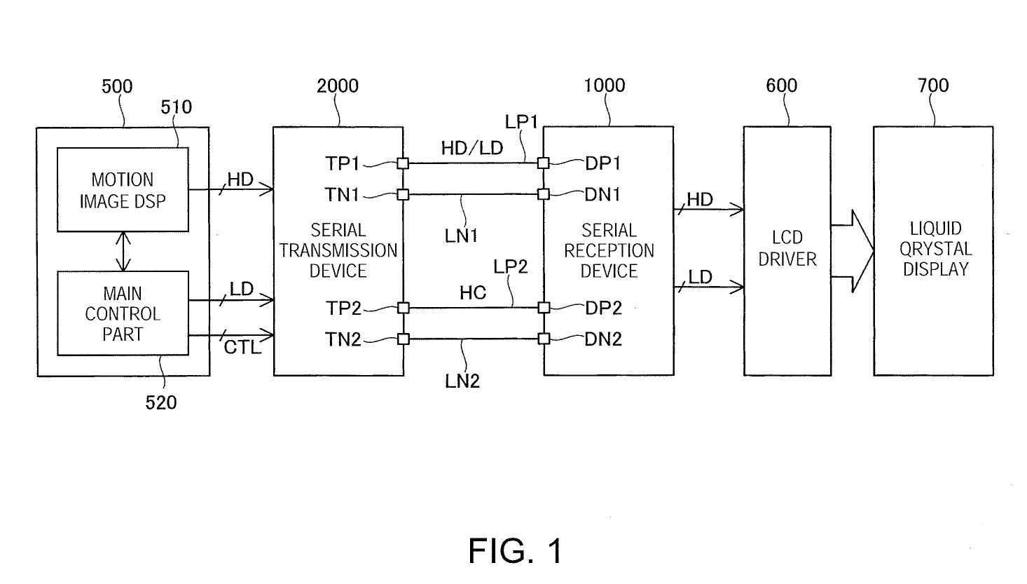

FIG. 1 is a rough construction diagram of a digital device of an embodiment. This digital device according to the embodiment includes an image processor 500; a transmitting and receiving system composed of a transmitter 2000 and a receiver 1000; an LCD driver 600; and a liquid crystal display 700 as a display device. The digital device is mounted on an electronic apparatus such as a cellular phone, and used for displaying still and moving images on the liquid crystal display 700.

The image processor 500 performs image processing to image data acquired from other components mounted on the electronic apparatus, such as a radio communication circuit or a storage device such as a flush memory. The image processor 500 is provided with a digital signal processor (DSP) 510 that is a computer specialized in image processing to moving image data, and a main control section 520 that is a computer performing other processing such as processing of still image data, or controlling the LCD driver 600 and the transmitter 2000.

The image processor 500 outputs data HD which is to be transmitted at high speed and data LD which is to be transmitted at low speed, to the transmitter 2000. The data HD which is to be transmitted at high speed is moving image data output from the DSP 510 in the embodiment. The data LD which is to be transmitted at low speed is data, other than the moving image data, such as still image data or control data to the LCD driver 600. The image processor 500 further outputs a control signal CTL to the transmitter 2000.

The transmitting and receiving system composed of the receiver 1000 and the transmitter 2000 is an interface transmitting the data LD and HD received from the image processor 500 to the LCD driver 600 in compliance with the control signal CTL received from the image processor 500. The transmitter 2000 is provided with two pairs of transmission terminals transmitting a differential signal, i.e. one terminal pair of a terminal TP1 and a terminal TN1, and the other terminal pair of a terminal TP2 and a terminal TN2. As mentioned later, the transmitter 2000 can transmit a single-end signal as well as the differential signal from each of these terminals.

The receiver 1000 is provided with two pairs of terminals respectively corresponding to the two pairs of the transmission terminals, i.e. one terminal pair of a terminal DP1 and a terminal DN1, and the other terminal pair of a terminal DP2 and a terminal DN2. As shown in FIG. 1, the terminals TP1, TN1, TP2, and TN2 of the transmitter 2000 respectively correspond to the terminals DP1, DN1, DP2, and DN2 of the receiver 1000, and corresponding terminals, i.e. TP1 and DP1, TN1 and DN1, TP2 and DP2, and TN2 and DN2 are respectively connected by signal lines LP1, LN1, LP2, and LN2. Thus, the receiver 1000 can receive the differential signal and the single end signal from the transmitter 2000 via these signal lines.

The LCD driver 600 receives the image data and the control data from the image processor 500 via the transmitting and receiving system described above, and drives the liquid crystal display 700 based on the data.

### Structure of Transmitter

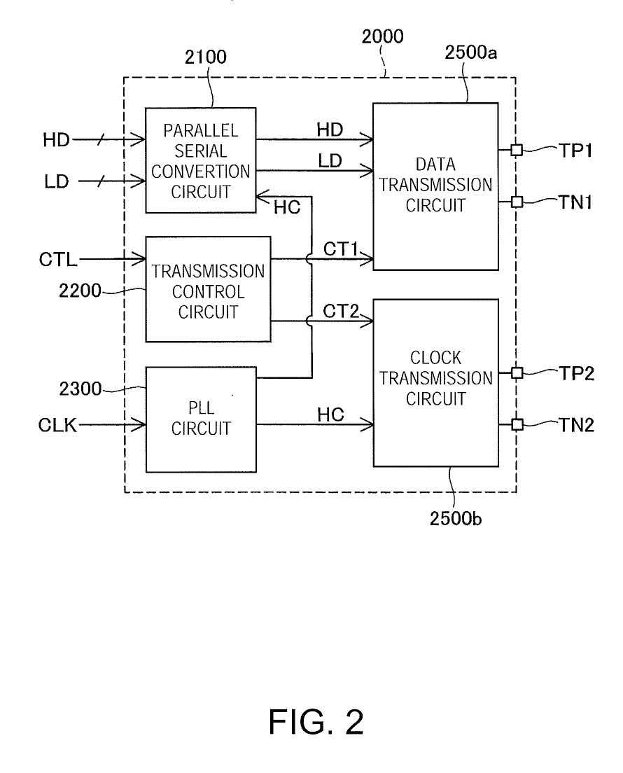

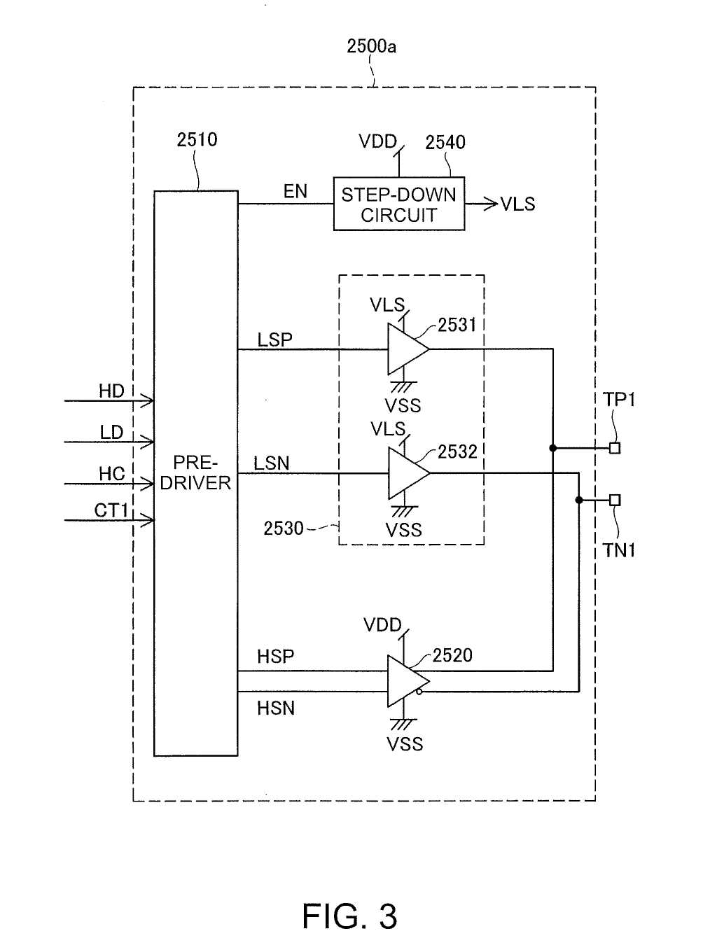

The transmitter 2000 will be further described with reference to FIGS. 2 and 3. FIG. 2 is an explanatory diagram showing an inner structure of the transmitter. FIG. 3 is an explanatory diagram showing an inner structure of a data transmission circuit.

As shown in FIG. 2, the transmitter 2000 includes a parallel serial conversion circuit 2100, a transmission control circuit 2200, a phase locked loop (PLL) circuit 2300, a data transmission circuit 2500a, and a clock transmission circuit 2500b as well as the above-described terminals TP1, TN1, TP2, and TN2. The PLL circuit 2300 generates high speed transmission clock HC in response to a reference clock signal CLK. The parallel serial conversion circuit 2100 converts the data HD and LD, being parallel and received from the image processor 500, into serial data so as to transmit the serial data to the data transmission circuit 2500a. The data HD which is to be transmitted at high speed is synchronized with the high speed transmission clock HC to be parallel/serial-converted. The transmission control circuit 2200 controls the data transmission circuit 2500a and the clock transmission circuit 2500b in response to the control signal CTL supplied from the image processor 500.

The data transmission circuit 2500a performs high speed transmission of the data HD which is to be transmitted at high speed and low speed transmission of the data LD which is to be transmitted at low speed in response to the control signal supplied from the transmission control circuit 2200. In particular, as shown in FIG. 3, the data transmission circuit 2500a is provided with a pre-driver 2510, a differential driver 2520, a single end driver 2530, and a step-down circuit 2540.

The pre-driver 2510 outputs signals HSP and HSN driving the differential driver 2520 in response to the control signal CT1 which expresses high speed transmission request, and the data HD which is to be transmitted at high speed. The signals HSP and HSN have opposite phases to each other. The differential driver 2520 receives the driving signals HSP and HSN to output a differential signal to the signal lines LP1 and LN1 via the terminals TP1 and TN1. Thus, the data HD is transmitted as a differential signal to the receiver 1000. The differential driver 2520 is a common differential driver composed of a constant current source and an N-channel field-effect transistor which are not shown. Hereinafter, the N-channel field-effect transistor is called an N-transistor, and a P-channel field-effect transistor is called a P-transistor. The differential driver 2520 receives a power supply voltage VDD (1.8 V in the embodiment) as a driving voltage and connected to a reference voltage VSS.

The pre-driver 2510 outputs signals LSP and LSN driving the single end driver 2530 in response to the control signal CT1 which expresses low speed transmission request, and the data LD which is to be transmitted at low speed. The single end driver 2530 is composed of a first single end transmission circuit 2531 to which the signal LSP is input and a second single end transmission circuit 2532 to which the signal LSN is input. The first single end transmission circuit 2531 is a push-pull inverter circuit coupled between an adjustment voltage VLS and a reference voltage VSS, and outputs a single end signal via the terminal TP1 to the signal line LP1 in response to the driving signal LSP. The second single end transmission circuit 2532 is a push-pull inverter circuit coupled between an adjustment voltage VLS and a reference voltage VSS, and outputs a single end signal via the terminal TN1 to the signal line LN1 in response to the driving signal LSN. Thus, the data LD is transmitted as two single end signals to the receiver 1000.

The step-down circuit 2540 converts a power supply voltage VDD being input (1.8 V in the embodiment), into the adjustment voltage VLS (1.2 V in the embodiment) to output. The step-down circuit 2540 is a switching regulator, for example, which switches an electric power being input by repeatedly turning on and off a semiconductor switch such as a power MOSFET (metal oxide semiconductor field effect transistor) so as to control an output voltage. An operation of the step-down circuit 2540 is controlled by an enable signal EN supplied from the pre-driver 2510. When the single end driver 2530 driven by the adjustment voltage VLS is stopped, the step-down circuit 2540 is allowed to stop its operation so as to reduce the electric power consumption.

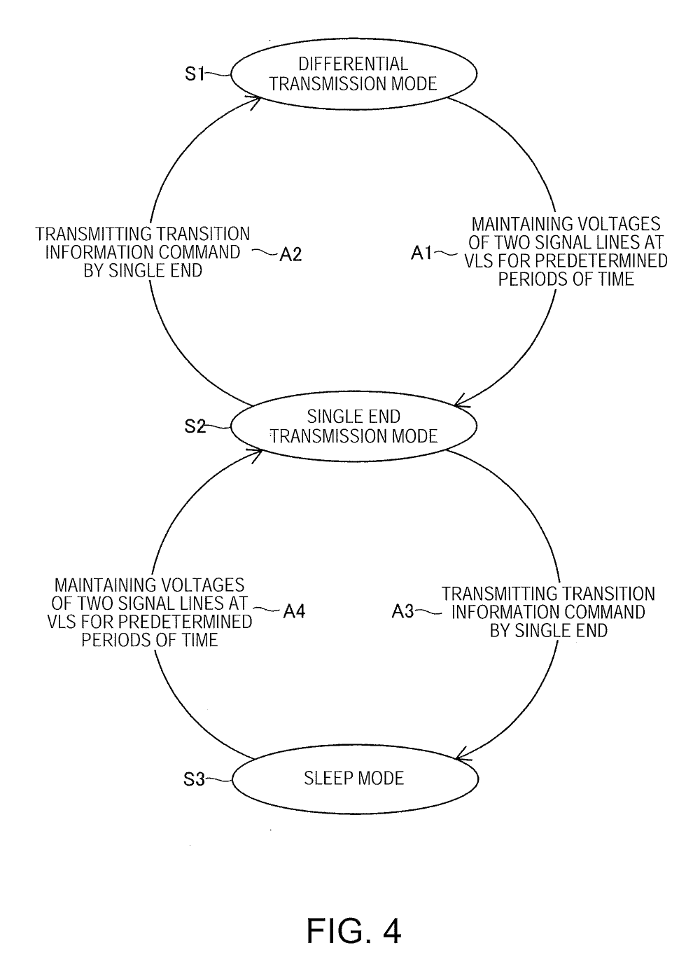

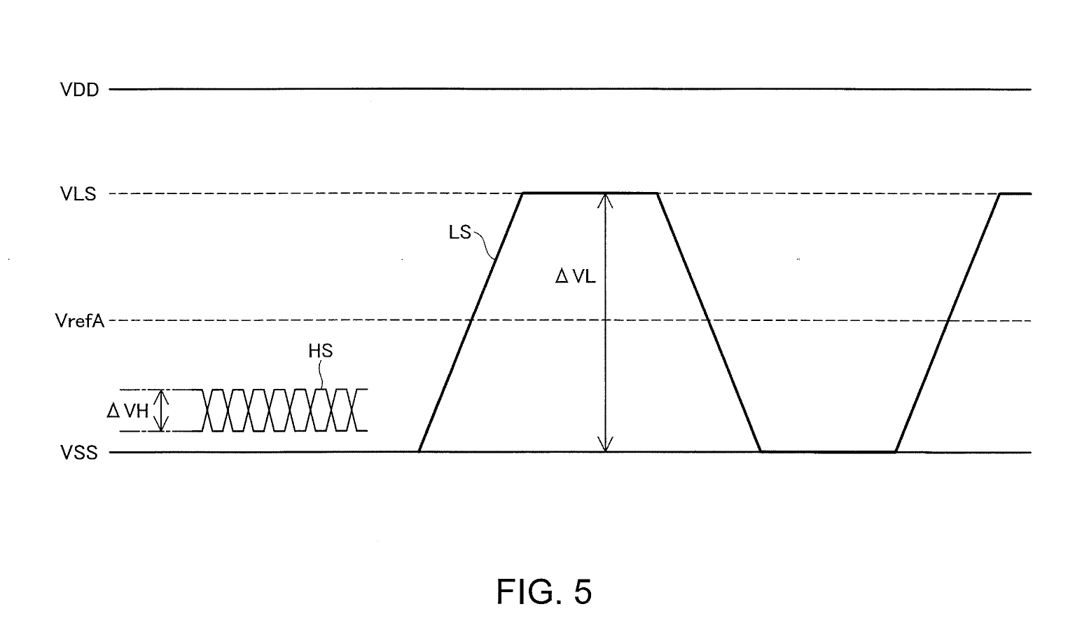

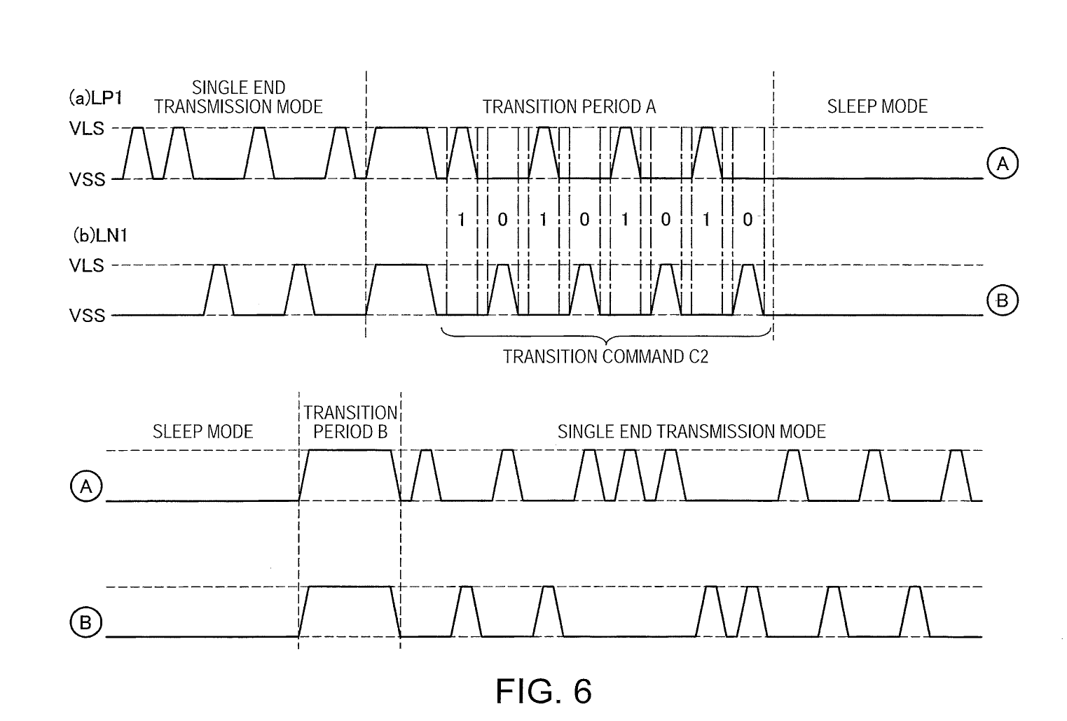

Here, the operation of the data transmission circuit 2500a will be further described with reference to FIGS. 4 to 6. FIG. 4 is an explanatory diagram showing a state transition of the data transmission circuit. FIG. 5 is a schematic view explaining a differential signal and a single end signal. FIG. 6 is a timing chart showing a voltage of a signal line in a single end transmission mode and a sleep mode.

As shown in FIG. 4, the data transmission circuit 2500a has, as operation modes, a differential transmission mode S1 in which the data HD is transmitted at high speed by a differential signal, and a single end transmission mode S2 in which the data LD is transmitted at low speed by two single end signals. Amplitude ΔVH of the differential signal HS transmitted from the data transmission circuit 2500a in the differential transmission mode S1 is set to be approximately 200 mV, for example. On the other hand, as understood from the circuit structure of the single end driver 2530 shown in FIG. 3, the single end signal LS transmitted from the data transmission circuit 2500a in the single end transmission mode S2 has the reference voltage VSS as a low signal and the adjustment voltage VLS as a high signal (refer to FIG. 5). Amplitude ΔVL (VLS−VSS) of the single end signal LS is four to ten times larger than the amplitude ΔVH of the differential signal HS, and is set to be 1.2 V in the embodiment.

A threshold voltage VrefA of FIG. 5 is a threshold value for determining whether the single end signal LS is a low signal or a high signal. This value is set to be approximately a half voltage of the amplitude ΔVL of the single end signal LS, that is, VrefA=(VLS−VSS)×0.5, though it is determined depending on characteristics of a CMOS converter arranged in an input stage of the single end receiver 1530 mentioned later. The voltage of the differential signal HS is set not to excess the threshold voltage VrefA, even if variation due to mixing of noise and the like is considered, as well.

For example, a transmission rate of the differential signal HS is set to be approximately 500 Mb/s (megabit per second), and a transmission rate of the single end signal LS is set to be approximately 10 Mb/s.

Here is explained the reason why the single end signal LS is adopted for the low speed data transmission and the differential signal HS is adopted for the high-speed data transmission. As described above, the push-pull inverter circuit transmits the single end signal LS. The current consumption of this circuit increases in proportion to the transmission rate. In addition, the transmission rate of the single end signal LS cannot be raised very much due to its characteristics.

On the other hand, a differential amplifier circuit transmits the differential signal HS. The differential amplifier circuit has a characteristic that the current consumption thereof does not change greatly even whether the transmission rate is large or small. The transmission rate of the differential signal HS is raised more easily than that of the single end signal LS. Thus, it is advantageous to use the differential signal HS for the data transmission at relatively high transmission rate (for example, 500 Mb/s). On the other hand, it is advantageous to use the single end signal LS for the data transmission at relatively low transmission rate (for example, 10 Mb/s) viewing from current consumption. Therefore, the embodiment uses the single end signal LS and the differential signal HS separately in accordance with the transmission speed, as described above.

In the data transmission circuit 2500a, transition between the differential transmission mode S1 and the single end transmission mode S2 is controlled by the control signal CT1 supplied from the transmission control circuit 2200. In a case of a transition from the differential transmission mode S1 to the single end transmission mode S2, the data transmission circuit 2500a maintains voltages of the signal lines LP1 and LN1 at the voltage VLS (a high signal of the single end signal) for predetermined periods of time in the transition period as A1 in FIG. 4.

On the other hand, in a case of a transition from the single end transmission mode S2 to the differential transmission mode S1, the data transmission circuit 2500a transmits a predetermined transition information command C1 to the receiver 1000 by the single end signal LS in the transition period as A2 in FIG. 4. For example, the transition information command C1 is eight-bit data expressing “11111111”.

As shown in FIG. 4, the data transmission circuit 2500a can transmit to a sleep mode S3 as well as the above operation modes. As shown in FIG. 6, in the sleep mode S3, the data transmission circuit 2500a does not output a significant signal (a signal which transmits data or a command), but maintains the voltages of the signal lines LP1 and LN1 at the reference voltage VSS (0V in the embodiment).

The data transmission circuit 2500a transmits from the single end transmission mode S2 to the sleep mode S3 in accordance with the control signal CT1 supplied from the transmission control circuit 2200. In a case of a transition from the single end transmission mode S2 to the sleep mode S3, the data transmission circuit 2500a transmits a predetermined transition information command C2 to the receiver 1000 by the single end signal LS in the transition period (refer to a transition period A of FIG. 6) as A3 in FIG. 4. For example, the transition information command C2 is eight-bit data expressing “10101010” (refer to the transition period A in FIG. 6). In the embodiment, as shown in FIG. 6, a combination of the signal line LP1 being high and the signal line LN1 being low expresses a signal “1”, and a combination of the signal line LP1 being low and the signal line LN1 being high expresses a signal “0”.

In a case of a transition from the sleep mode S3 to the single end transmission mode S2, the data transmission circuit 2500a maintains the voltages of the signal lines LP1 and LN1 at the voltage VLS (a high signal of the single end signal) for predetermined periods of time in the transition period as A4 in FIG. 4.

Thus, the receiver 1000 detects distinctive signals in the transition periods between respective modes so as to recognize the mode transition in the transmitter 2000.

The clock transmission circuit 2500b outputs the differential signal HS and the single end signal LS via the terminals TP2 and TN2 to the signal lines LP2 and LN2. While the data transmission circuit 2500a transmits the data HD as the differential signal HS in the differential transmission mode S1, the clock transmission circuit 2500b transmits the high speed transmission clock HC supplied from the PLL circuit 2300 as the differential signal HS in the mode S1. The clock transmission circuit 2500b does not transmit data which is to be transmitted to the LCD driver 600 in the single end transmission mode S2. The data transmission circuit 2500a transmits only control commands for the receiver 1000 (for example, the transmission information commands C1 and C2 mentioned above) as the single end signal LS. The inner structure of the clock transmission circuit 2500b is basically same as the one of the data transmission circuit 2500a described with reference to FIG. 3, so that the detailed description thereof will be omitted. The transition processes between respective modes, i.e. the differential transmission mode S1, the single end transmission mode S2, and the sleep mode S3, in the clock transmission circuit 2500b are same as those of the data transmission circuit 2500a described with reference to FIG. 4, so that the detailed description thereof will be omitted, as well.

### Structure of Receiver

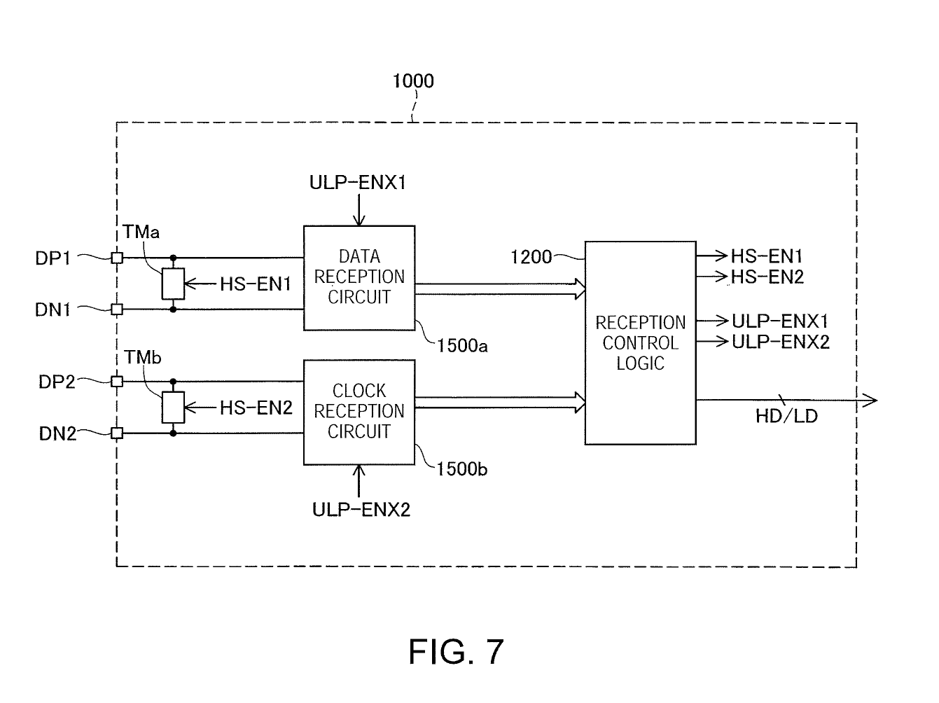

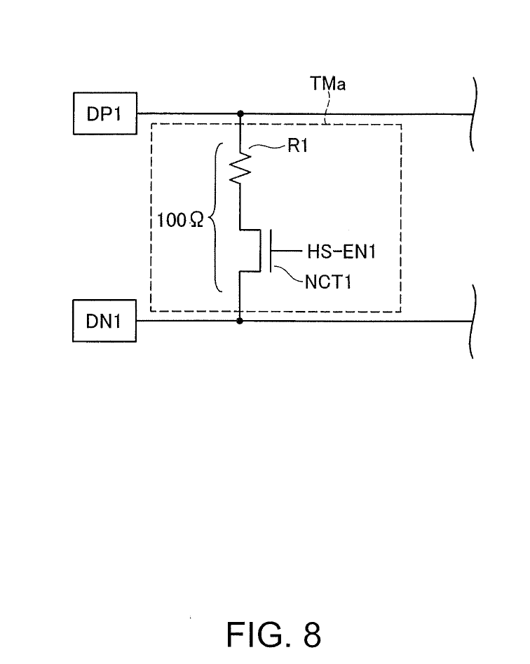

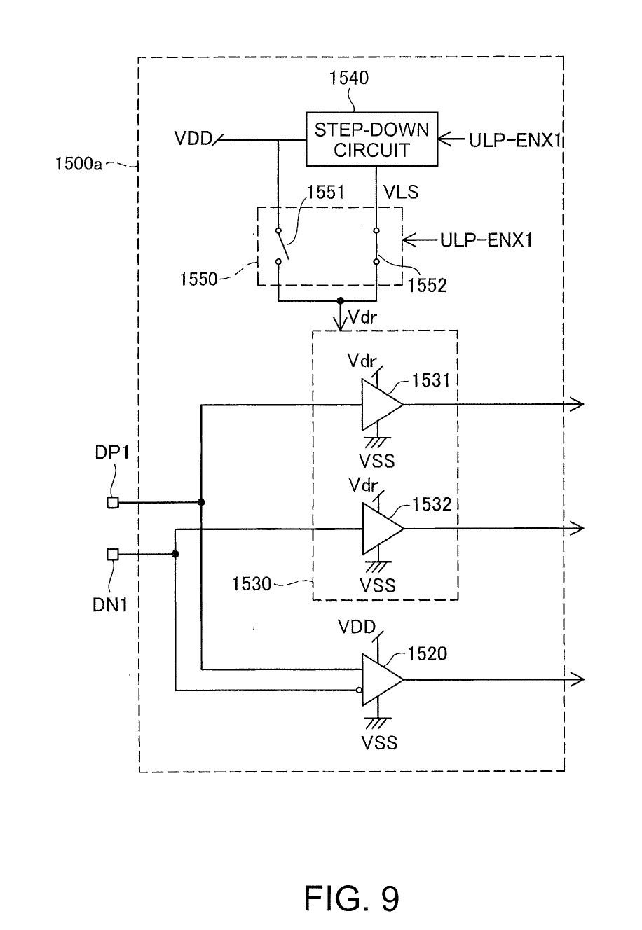

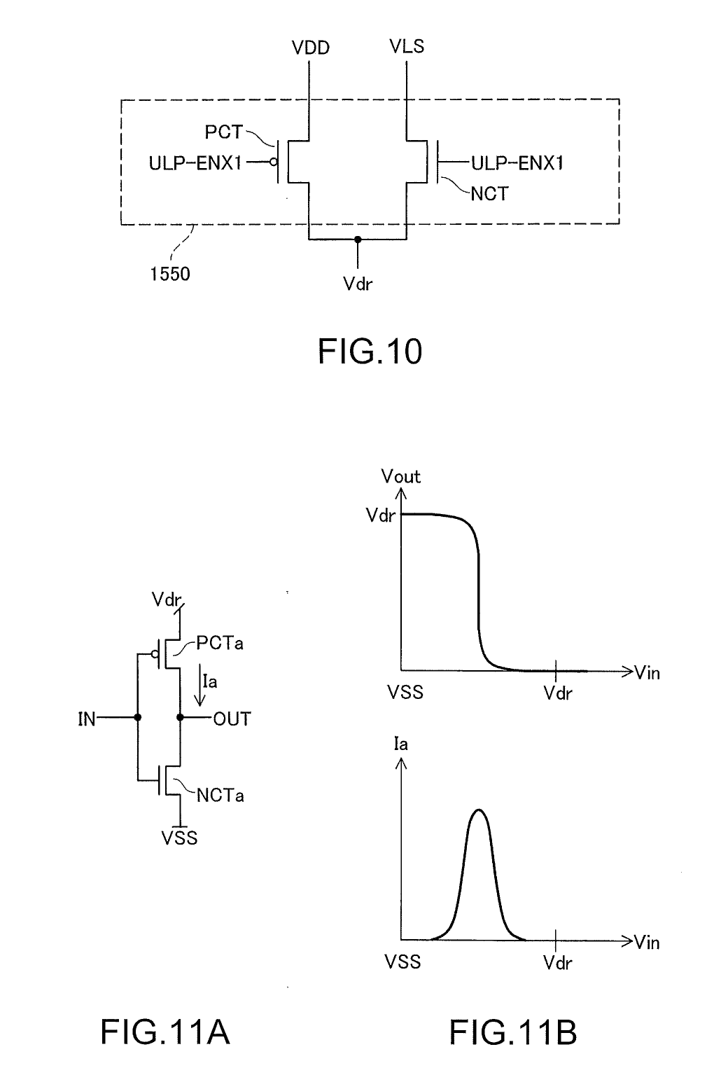

Next, further described with reference to FIGS. 7 to 11B is the receiver 1000 receiving the differential signal HS and the single end signal LS output from the transmitter 2000 described above via the signal lines LP1, LN1, LP2, and LN2. FIG. 7 is an explanatory diagram showing an inner structure of the receiver. FIG. 8 is an explanatory diagram showing an inner structure of a terminating circuit. FIG. 9 is an explanatory diagram showing an inner structure of a data receiving circuit. FIG. 10 is an explanatory diagram showing an example of a switching circuit. FIGS. 11A and 11B are explanatory diagrams explaining an input stage of the single end receiving circuit.

As shown in FIG. 7, the receiver 1000 is provided with terminating circuits TMa and TMb, a data receiving circuit 1500a, a clock receiving circuit 1500b, and a reception control logic 1200.

Here, the receiver 1000 receives signals at respective terminal pairs of terminals DP1 and DN1, and terminals DP2 and DN2 in two reception modes. The two reception modes are a differential reception mode in which the differential signal HS described above is received, and a single end reception mode in which the single end signal LS described above is received. Further, the receiver 1000 can transmit to the sleep mode as well as the two reception modes. These modes are controlled by a mode control signal output from the reception control logic 1200. The mode control signal includes HS-EN1 and ULP-ENX1 controlling the mode of the data receiving circuit 1500a which receives a signal via the terminal pair of the terminals DP1 and DN1, and HS-EN2 and ULP-ENX2 controlling the mode of the clock receiving circuit 1500b which receives a signal via the terminal pair of the terminals DP2 and DN2.

When controlling the data receiving circuit 1500a in the differential reception mode, the reception control logic 1200 makes HS-EN1 and ULP-ENX1 high. When controlling the clock receiving circuit 1500b in the differential reception mode, the reception control logic 1200 makes HS-EN2 and ULP-ENX2 high. When controlling the data receiving circuit 1500a in the single end reception mode, the reception control logic 1200 makes HS-EN1 low and ULP-ENX1 high. When controlling the clock receiving circuit 1500b in the single end reception mode, the reception control logic 1200 makes HS-EN2 low and ULP-ENX2 high. Further, when controlling the data receiving circuit 1500a in the sleep mode, the reception control logic 1200 makes HS-EN1 and ULP-ENX1 low. When controlling the clock receiving circuit 1500b in the sleep mode, the reception control logic 1200 makes HS-EN2 and ULP-ENX2 low.

The terminating circuit TMa terminates the differential signal HS received via the terminal pair of the terminals DP1 and DN1. As shown in FIG. 8, the terminating circuit TMa includes a terminating resistance R1 and an N-transistor NCT1 which are coupled in series between the terminals DP1 and DN1. Into a gate of the N-transistor NCT1 of the terminating circuit TMa, the above-mentioned mode-control signal HS-EN1 is input. Therefore, in the differential reception mode, namely when the HS-EN1 is high, the N-transistor NCT1 turns on, coupling the terminals DP1 and DN1 with the resistance R1 which is 100Ω interposed therebetween. On the other hand, in the single end reception mode S5 and the sleep mode S6, namely when the HS-EN1 is low, the N-transistor NCT1 turns off, turning the terminals DP1 and DN1 into a high impedance state.

The terminating circuit TMb terminates the differential signal HS received via the terminal pair of the terminals DP2 and DN2. The terminating circuit TMb receives the signal HS-EN2. The specific structure of the terminating circuit TMb is same as the one of the terminating circuit TMa described with reference to FIG. 8, so that the detailed description thereof will be omitted.

The data receiving circuit 1500a receives the differential signal HS and the single end signal LS supplied via the terminal pair of the terminals DP1 and DN1. As shown in FIG. 9, the data receiving circuit 1500a includes a single end signal-receiving unit 1530, a differential receiver 1520, a step-down circuit 1540, and a switching circuit 1550. The single end signal-receiving unit 1530 includes a first single end receiver 1531 coupled with the terminal DP1 and a second single end receiver 1532 coupled with the terminal DN1. The differential receiver 1520 is coupled to the two terminals DP1 and DN1.

The differential receiver 1520 has a known structure including a differential amplifier circuit as a main part, and converts the differential signal HS input via the two terminals DP1 and ND1 (the signal lines LP1 and LN1) into the single end signal LS to output.

The first single end receiver 1531 and the second single end receiver 1532 respectively receive a driving voltage Vdr and are coupled with a reference voltage VSS. Here, the first single end receiver 1531 and the second single end receiver 1532 are provided with a CMOS inverter shown in FIG. 11A at their input stages respectively coupled to the terminals DP1 and DN1.

As shown in FIG. 11A, the CMOS inverter includes a P-transistor PCTa and an N-transistor NCTa which are coupled in series between the driving voltage Vdr being input and the reference voltage VSS. The voltages of the terminals are input into gates of the two transistors. FIG. 11B shows characteristics of the CMOS inverter. As shown in FIGS. 11A and 11B, when an input voltage is the reference voltage VSS or the driving voltage Vdr, through current Ia flowing in the CMOS inverter is zero, so that the CMOS inverter substantively consumes no electric power. On the other hand, when the input voltage is between the reference voltage VSS and the driving voltage Vdr, the through current Ia flows in the CMOS inverter, so that the CMOS inverter consumes electric power.

Due to such characteristics of the CMOS inverter, when the voltage of the terminal DP1 (the voltage of the signal line LP1) is maintained at the reference voltage VSS, the first single end receiver 1531 consumes no electric power substantively, even if the driving voltage Vdr is input thereinto. Of course, leakage current leaking from the transistor which is in the off state may occur, so that the electric power is possibly consumed. However, the idea that “no electric power is consumed substantively” in this embodiment permits the occurrence of some leakage current. In the same manner, when the voltage of the terminal DP1 (the voltage of the signal line LP1) is maintained at the driving voltage Vdr, the first single end receiver 1531 consumes no electric power substantively, even if the driving voltage Vdr is input thereinto.

Due to the same reason as the first single end receiver 1531, when the voltage of the terminal DN1 is maintained at the reference voltage VSS or the driving voltage Vdr, the second single end receiver 1532 substantively consumes no electric power, even if the driving voltage Vdr is input thereinto.

As described above, the voltage of the high signal of the single end signal LS transmitted via the terminals DP1 (the signal line LP1) and DN1 (the signal line LN1) is the adjustment voltage VLS (1.2 V in the embodiment). Therefore, when receiving the single end signal LS, the first single end receiver 1531 and the second single end receiver 1532 preferably receive the adjustment voltage VLS as the driving voltage Vdr. That is because the first single end receiver 1531 can restrain its electric power consumption.

In the same manner of the step-down circuit 2540 in the data transmission circuit 2500a, the step-down circuit 1540 converts the power supply voltage VDD being input (1.8 V in the embodiment) into the adjustment voltage VLS (1.2 V in the embodiment) to output. As the step-down circuit 1540, a switching regulator is adopted, for example, as is the case with the step-down circuit 2540. An operation of the step-down circuit 1540 is controlled by the above-mentioned mode-control signal ULP-ENX1 supplied from the reception control logic 1200. When the data receiving circuit 1500a is in the sleep mode, namely when the ULP-ENX1 is low, the step-down circuit 1540 is allowed to stop its operation so as to reduce the electric power consumption. On the other hand, when the data receiving circuit 1500a is not in the sleep mode, namely when the ULP-ENX1 is high, the step-down circuit 1540 outputs the adjustment voltage VLS as described above.

The switching circuit 1550 switches the driving voltage Vdr which is input into the single end signal-receiving unit 1530, to the power supply voltage VDD or the adjustment voltage VLS. The switching circuit 1550 includes a first switch 1551 and a second switch 1552. The switching circuit 1550 is controlled by the above-mentioned mode-control signal ULP-ENX1 supplied from the reception control logic 1200. In the switching circuit 1550, when the data receiving circuit 1500a is in the sleep mode, namely when the ULP-ENX1 is low, the first switch 1551 is turned on and the second switch 1552 is turned off. Therefore, when the data receiving circuit 1500a is in the sleep mode, the driving voltage Vdr which is input into the single end signal-receiving unit 1530 is the power supply voltage VDD. On the other hand, when the data receiving circuit 1500a is not in the sleep mode S6, namely when the ULP-ENX1 is high, the first switch 1551 is turned off and the second switch 1552 is turned on. Therefore, when the data receiving circuit 1500a is not in the sleep mode, the driving voltage Vdr which is input into the single end signal-receiving unit 1530 is the adjustment voltage VLS.

FIG. 10 illustrates a specific structure of the switching circuit 1550. As understood by FIG. 10, for example, a P-transistor PCT is used as the first switch 1551, and an N-transistor NCT is used as the second switch 1552. Each of the transistors works as a semiconductor switch which is on/off controlled by the mode-control signal ULP-ENX1 which is input into each gate thereof.

The clock receiving circuit 1500b receives the differential signal HS and the single end signal LS supplied via the terminal pair of the terminals DP2 and DN2. The clock receiving circuit 1500b has the same structure as the one of the data receiving circuit 1500a described with reference to FIG. 9, so that the description thereof will be omitted.

The reception control logic 1200 is a logic circuit mainly performing serial parallel conversion process and a protocol process. In the serial parallel conversion process, serial data included in a signal received from the data receiving circuit 1500a is converted into parallel data. In the protocol process, the data HD and the data LD are taken out from the parallel data which has been converted, so as to be transmitted to the LCD driver 600. High speed serial data received as the differential signal HS is synchronized with high speed transmission clock HC received from the clock receiving circuit 1500b to be converted into parallel data. Low speed serial data received as the single end signal LS is synchronized with a self clock signal included in the low speed serial data itself to be converted into parallel data.

Further, as mentioned above, the reception control logic 1200 outputs the mode-control signals HS-EN1 and ULP-ENX1 controlling the mode of the data receiving circuit 1500a, and the mode-control signals HS-EN2 and ULP-ENX2 controlling the mode of the clock receiving circuit 1500b so as to control the whole operation of the receiver 1000.

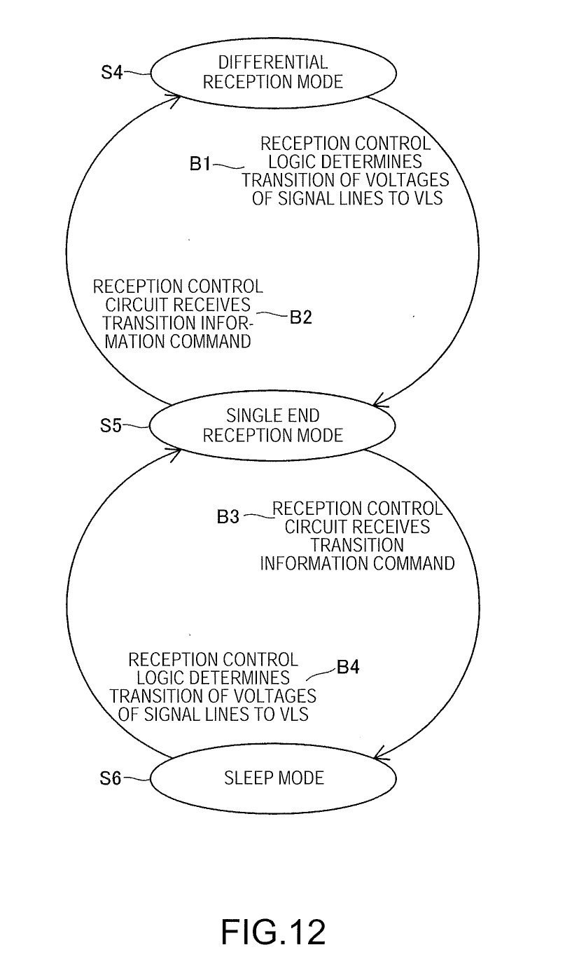

Control over the receiver 1000 by the reception control logic 1200 will be described with reference to FIG. 12. FIG. 12 is an explanatory diagram showing a state transition of the data receiving circuit and the clock receiving circuit. In a case where the data receiving circuit 1500a is in a differential reception mode S4, when the reception control logic 1200 determines that the voltages of the terminals DP1 and DN1 (the voltages of the signal lines LP1 and LN1) transmit to the level of VLS in accordance with an output from the data receiving circuit 1500a as B1 in FIG. 12, the reception control logic 1200 shifts the mode-control signal HS-EN1 controlling the mode of the data receiving circuit 1500a, from high to low. Namely, when the reception control logic 1200 detects that the mode of the data transmission circuit 2500a transmits from the differential transmission mode S1 to the single end transmission mode S2, the mode of the data receiving circuit 1500a transmits from the differential reception mode S4 to the single end reception mode S5.

On the other hand, in a case where the data receiving circuit 1500a is in the single end reception mode S5, when the reception control logic 1200 receives a predetermined transition information command C1 (for example, “11111111” as mentioned above) included in an output from the data receiving circuit 1500a as B2 in FIG. 12, the reception control logic 1200 shifts the mode-control signal HS-EN1 controlling the mode of the data receiving circuit 1500a, from low to high. Namely, when the reception control logic 1200 receives the transition information command C1 to detect the transition of the mode of the data transmission circuit 2500a from the single end transmission mode S2 to the differential transmission mode S1, the mode of the data receiving circuit 1500a transmits from the single end reception mode S5 to the differential reception mode S4.

Further, in a case where the data receiving circuit 1500a is in the single end reception mode S5, when the reception control logic 1200 receives a predetermined transition information command C2 (for example, “10101010” as mentioned above) included in an output from the data receiving circuit 1500a as B3 in FIG. 12, the reception control logic 1200 shifts the mode-control signal ULP-ENX1 controlling the mode of the data receiving circuit 1500a, from high to low. Namely, when the reception control logic 1200 receives the transition information command C2 to detect the transition of the mode of the data transmission circuit 2500a from the single end transmission mode S2 to the sleep mode S3, the mode of the data receiving circuit 1500a transmits from the single end reception mode S5 to the sleep mode S6.

In a case where the data receiving circuit 1500a is in the sleep mode S6, when the reception control logic 1200 determines that the voltages of the terminals DP1 and DN1 (the voltages of the signal lines LP1 and LN1) transmit to the level of VLS in accordance with an output from the data receiving circuit 1500a as B4 in FIG. 12, the reception control logic 1200 shifts the mode-control signal ULP-ENX1 controlling the mode of the data receiving circuit 1500a, from low to high. Namely, when the reception control logic 1200 detects the transition of the mode of the data transmission circuit 2500a from the sleep mode S3 to the single end transmission mode S2, the mode of the data receiving circuit 1500a transmits from the sleep mode S6 to the single end reception mode S5.

As understood from the above description, the reception control logic 1200 has a function of a determination circuit.

Further, the reception control logic 1200 controls the mode of the clock receiving circuit 1500b in three modes, i.e. the differential reception mode S4, the single end reception mode S5, and the sleep mode S6, in accordance with an output from the clock receiving circuit 1500b as is the case with the data receiving circuit 1500a. The process of controlling the clock receiving circuit 1500b is same as the one of the data receiving circuit 1500a, so that the description thereof will be omitted.

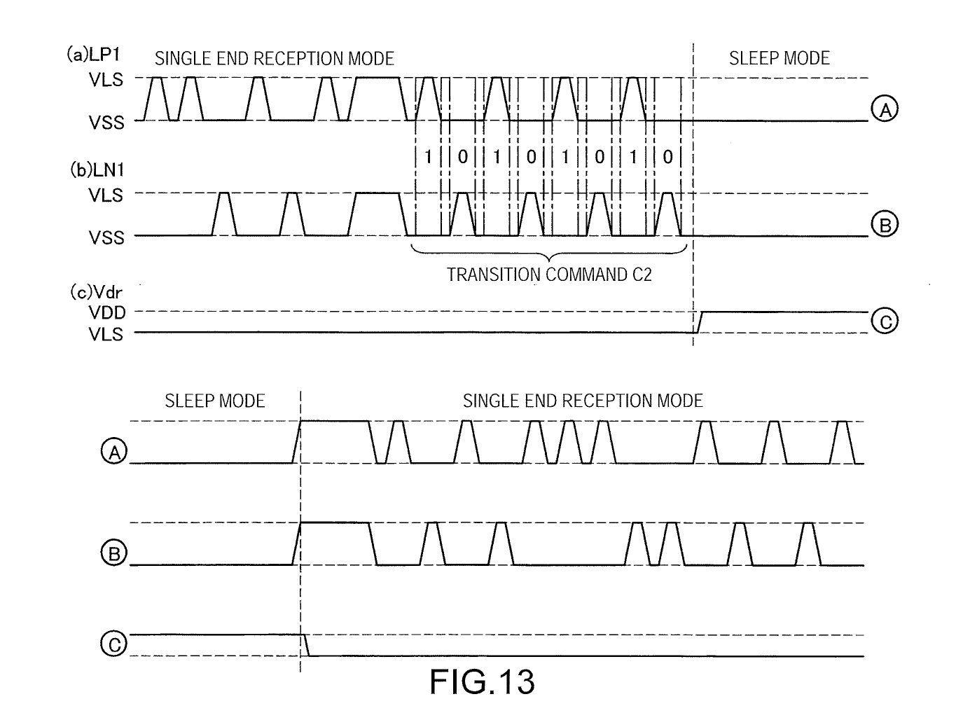

According to the receiver 1000 described above in the embodiment, the following advantageous effects are provided. FIG. 13 is a timing chart showing a voltage of a signal line and a driving voltage of the single end signal-receiving unit in the single end reception mode and the sleep mode. As shown in FIG. 13, in the single end reception mode S5, the driving voltage Vdr which is input into the single end signal-receiving unit 1530 is brought to be the adjustment voltage VLS which is a same voltage as the high level voltage of the single end signal LS. Therefore, the single end signal-receiving unit 1530 can efficiently receive the single end signal LS without unnecessary electric power consumption.

On the other hand, in the sleep mode S6, the driving voltage Vdr which is input into the single end signal-receiving unit 1530 is brought to be the power supply voltage VDD and an operation of the step-down circuit 1540 is stopped. In the sleep mode S6, voltages of the signal lines LP1 and LN1 are maintained at the reference voltage VSS. Therefore, even if the power supply voltage VDD is input, the single end signal-receiving unit 1530 consumes no electric power substantively, as mentioned above. Consequently, in the sleep mode S6, the electric power consumption in the step-down circuit 1540 can be made zero, and the single end signal-receiving unit 1530 consumes no electric power substantively.

Further, in the sleep mode S6, since the power supply voltage VDD is supplied to the single end signal-receiving unit 1530, the transition of the transmitter 2000 from the sleep mode S3 to the single end transmission mode S2 can be detected from an output of the single end signal-receiving unit 1530. Namely, as shown in the lower part of FIG. 13, in a case where the transmitter 2000 transmits from the sleep mode S3 to the single end transmission mode S2, when voltages of the signal lines LP1 and LN1 rise from the reference voltage VSS to the adjustment voltage VLS, an output of the single end signal-receiving unit 1530 shifts from low to high. Then the reception control logic 1200 receiving the output operates the step-down circuit 1540 and inputs the adjustment voltage VLS output from the step-down circuit 1540 to the single end signal-receiving unit 1530 as the driving voltage Vdr. Therefore, it is not necessary to form a signal-monitoring unit (composed of a comparator, for example) of the known art for recovering from the sleep mode. Thus, the electric power consumption in the sleep mode S6 can be further reduced. In addition, since the independent signal-monitoring unit is not formed, the number of parts of the receiver 1000 can be reduced, being able to miniaturize the receiver 1000.

The data receiving circuit 1500a and the clock receiving circuit 1500b also provide such advantageous effect, as is apparent from their similar structures.

### Modifications

### First Modification

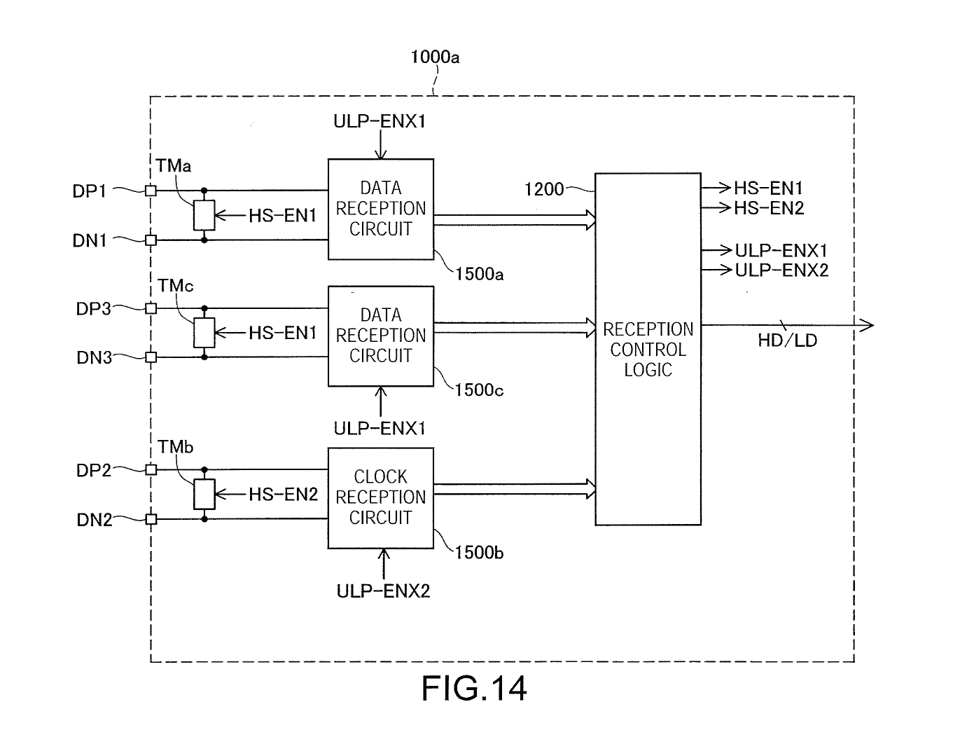

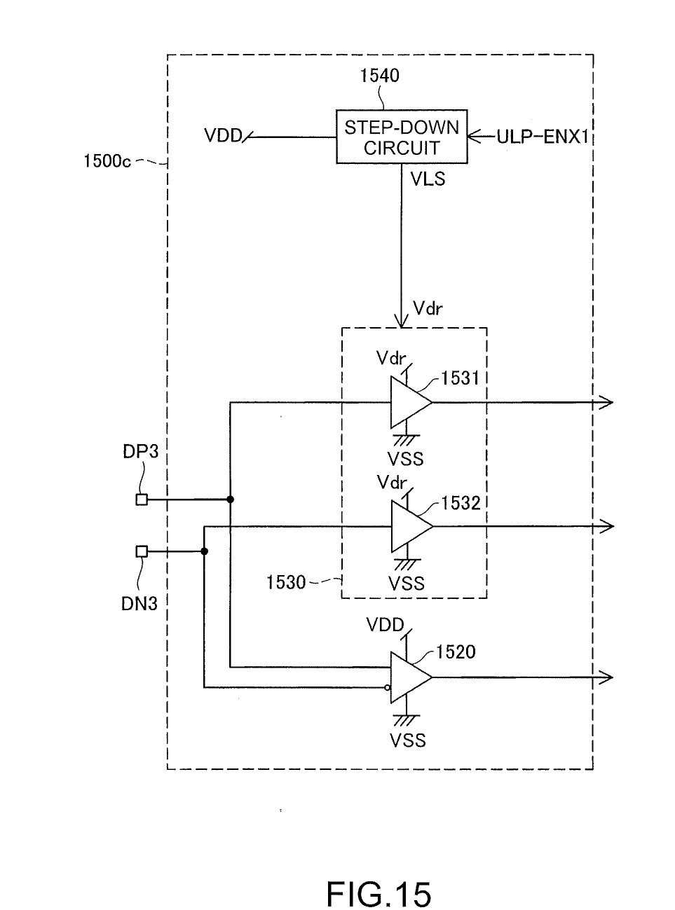

A receiver 1000a according to a first modification will be described with reference to FIGS. 14 and 15. FIG. 14 is an explanatory diagram showing an inner structure of the receiver of the first modification. FIG. 15 is an explanatory diagram showing an inner structure of another data reception part. As shown in FIG. 14, this receiver 1000a includes another data receiving circuit 1500c, another terminal pair of a terminal DP3 and a terminal DN3, a terminating circuit TMc for the terminal pair of the terminals DP3 and DN3 in addition to the structures of the receiver 1000 in the embodiment. The structures are same as the ones of the receiver 1000 in the embodiment described with reference to FIG. 7, so that the same reference numbers are given them in FIG. 14 and the descriptions thereof will be omitted. The inner structure of the terminating circuit TMc is same as the one of the terminating circuit TMa described with reference to FIG. 8, so that the description thereof will be omitted.

The data receiving circuit 1500c does not include a switching circuit 1550, as different from the data receiving circuit 1500a described with reference to FIG. 9. In the data receiving circuit 1500c, the single end signal-receiving unit 1530 constantly receives an output of the step-down circuit 1540 as a driving voltage Vdr. Therefore, when an operation of the step-down circuit 1540 is stopped (when the ULP-ENX1 is low), the driving voltage Vdr is zero (VSS). On the other hand, when the step-down circuit 1540 operates (when the ULP-ENX1 is high), the driving voltage Vdr is the adjustment voltage VLS.

A mode of the data receiving circuit 1500c is controlled by the mode-control signals HS-EN1 and ULP-ENX1 output from the reception control logic 1200, as is the case of the data receiving circuit 1500a. Namely, the data receiving circuit 1500c shifts the mode thereof while synchronizing with the data receiving circuit 1500a. As understood from the structure shown in FIG. 15, when the data receiving circuit 1500c is in the sleep mode S6 (when the ULP-ENX1 is low), the operation of the single end signal-receiving unit 1530 is stopped as well as the operation of the step-down circuit 1540 (no power supply voltage VDD is supplied to the driving voltage Vdr). When the data receiving circuit 1500c is in the single end reception mode S5 (when the ULP-EXN1 is high), the step-down circuit 1540 operates to output the adjustment voltage VLS, so that the adjustment voltage VLS is supplied as the driving voltage Vdr to the single end signal-receiving unit 1530.

A transmitter (not shown) coupled to the receiver 1000a of the first modification includes another terminal pair, and another data transmission circuit which transmits the single end signal LS and the differential signal HS via the another terminal pair, as corresponding to the receiver 1000a. Of course, the transmitter corresponding to the receiver 1000a is coupled to the receiver 1000a by another pair of signal lines. In the first modification, modes of two data transmission circuits of the transmitter are controlled to synchronize with each other to transmit. Namely, a transition from the single end transmission mode S2 to the sleep mode S3, or a transition from the sleep mode S3 to the single end transmission mode S2 is performed in the two data transmission circuits at the same time.

Since the data receiving circuit 1500c stops the operation of the single end signal-receiving unit 1530 in the sleep mode S6, the data receiving circuit 1500c can not detect a recovery from the sleep mode S6 to the single end reception mode S5 by itself. However, the data receiving circuit 1500c can shift its mode by synchronizing with the data receiving circuit 1500a.

According to the receiver 1000a of the first modification structured as above, the data receiving circuit 1500c shifts its mode by synchronizing with the data receiving circuit 1500a. Therefore, the operation of the single end signal-receiving unit 1530 of the data receiving circuit 1500c can be completely stopped in the sleep mode S6. Consequently, in the sleep mode S6, the single end signal-receiving unit 1530 of the data receiving circuit 1500c does not require an input of the power supply voltage VDD, and no leakage current occurs. Thus, the receiver 1000a can further reduce its electric power consumption.

As understood from the above description, when there is a plurality of data receiving circuits of which modes synchronize with each other to transmit, it is enough to supply the power supply voltage VDD to the single end signal receiving part 1530 of one data receiving circuit, and operations of the single end signal-receiving unit 1530 of other data receiving circuits may be stopped.

### Second Modification

On the other hand, when there is a plurality of data receiving circuits of which modes transmit asynchronously, it is enough to supply the power supply voltage VDD to the single end signal receiving part 1530 of each data receiving circuit, and the reception control logic 1200 separately controls the mode transition of each data receiving circuit.

### Third Modification

In the embodiment, the transmitting and receiving system including the receiver 1000 and the transmitter 2000 is used as an interface between the image processor 500 and the LCD driver 600, but not limited to this. For example, the transmitting and receiving system may be used as an interface for various communications such as communication between chips, communication between boards, communication between various device modules, and communication within a back plane for mounting a circuit substrate.

### Fourth Modification

The transmitting and receiving system of the embodiment is a one-way communication system in which the transmitter side and the receiver side are fixed, but alternatively the transmitting and receiving system may be applied as a two-way communication system. In this case, it is enough to provide transceivers including functions of the data receiving circuit 1500a and the data transmission circuit 2500a, on both ends of the respective signal lines LP1 and LN1.

### Fifth Modification

In the embodiment, since the adjustment voltage VLS is lower than the power supply voltage VDD, the step-down circuit 1540 is provided. In a case where the adjustment voltage VLS is higher than the power supply voltage VDD, for example when the adjustment voltage VLS is 1.2 V and the power supply voltage VDD is 1.8 V, a step-up circuit which steps up the power supply voltage VDD to output the adjustment voltage VLS may be provided as substitute for the step-down circuit 1540. The power supply VDD is generally brought to match an operation voltage of peripheral circuits such as the reception control logic 1200 and the LCD driver 600. On the other hand, since a value of the adjustment voltage VLS is brought to match the high level of the single end signal LS, the value is often determined by specifications, for example. That is, there are both possibilities that the adjustment voltage VLS is lower than the power supply voltage VDD, and that the adjustment voltage VLS is higher than the power supply voltage VDD.

While the present invention is described in accordance with the above embodiment and modifications, the embodiment does not limit the invention but facilitates understanding of the present invention. Note that various modifications and improvements can be made without departing from the scope of the invention, and the invention includes its equivalents.

What is claimed is:

1. A receiver coupled with a transmitter, the transmitter having a first mode in which a first signal including a first voltage and a reference voltage is output to at least one signal line and a second mode in which the at least one signal line is maintained as the reference voltage, via the at least one signal line, comprising:
a power supply outputting a second voltage;
a voltage conversion circuit converting the second voltage output from the power supply into the first voltage and outputting the first voltage; and
a receiving circuit coupled with the at least one single line,
wherein the first voltage output from the voltage conversion circuit is input into the receiving circuit as a driving voltage in a case where the transmitter is in the first mode;
wherein an operation of the voltage conversion circuit is stopped in a case where the transmitter is in the second mode; and
wherein, in a process of transiting from the second mode to the first mode, in a case when the transmitter shifts a voltage of the at least one signal line from the reference voltage to the first voltage, the second voltage is input into the receiving circuit as the driving voltage.

2. A receiver coupled with a transmitter, the transmitter having a first mode in which a first signal including a first voltage and a reference voltage is output to at least one signal line and a second mode in which the at least one signal line is maintained as the reference voltage, via the at least one signal line, comprising:
a power supply outputting a second voltage;
a voltage conversion circuit converting the second voltage output from the power supply into the first voltage to output;
a receiving circuit, the receiving circuit being coupled with the at least one signal line, and being free from electric power consumption thereof in a case where the signal line is maintained as the reference voltage and in a case where the signal line is maintained as a driving voltage being input; and
a voltage control circuit, the voltage control circuit inputting the first voltage output from the voltage conversion circuit to the receiving circuit as the driving voltage in a case where the transmitter is in the first mode, and inputting the second voltage output from the power supply to the receiving circuit as the driving voltage while stopping an operation of the voltage conversion circuit in a case where the transmitter is in the second mode.

3. The receiver according to claim 1, wherein the receiving circuit includes an inverter circuit, the inverter circuit operated by the driving voltage and the reference voltage, in an input stage thereof coupled to the at least one signal line.

4. The receiver according to claim 2, wherein the voltage control circuit includes: a determination circuit determining whether the transmitter is in the first mode or the second mode based on an output from the receiving circuit; and a switching circuit switching a voltage, the voltage being controlled by the determination circuit and input into the receiving circuit as the driving voltage, to the first voltage output from the voltage conversion circuit and the second voltage output from the power supply.

5. The receiver according to claim 1, wherein the voltage conversion circuit is a step-down circuit outputting the first voltage being lower than the second voltage.

6. The receiver according to claim 1, wherein the voltage conversion circuit is a step-up circuit outputting the first voltage being higher than the second voltage.

7. The receiver according to claim 2, further comprising:
at least one other receiving circuit receiving a different signal from the transmitter via a signal line different from the at least one signal line,
wherein
the voltage control circuit inputs the first voltage output from the voltage conversion circuit to the at least one other receiving circuit as the driving voltage in a case where the transmitter is in the first mode, and stops an operation of the at least one other receiving circuit in a case where the transmitter is in the second mode.

8. The receiver according to claim 1, further comprising:
a differential receiving circuit receiving a differential signal via two signal lines, wherein
the at least one signal line is out of the two signal lines;
the first signal transmitted in the first mode is a single end signal transmitted via at least one signal line out of the two signal lines; and
the transmitter further has a third mode in which the differential signal is transmitted at high speed via the two signal lines.

9. A device including the receiver according to claim 1 and a display driver driving a display by using image data received by the receiver.

10. A transmitting and receiving system, comprising:
at least one signal line;
a transmitter having a first mode in which a first signal including a first voltage and a reference voltage is output to the at least one signal line and a second mode in which the at least one signal line is maintained at the reference voltage; and
a receiver including:
a power supply outputting a second voltage;
a voltage conversion circuit converting the second voltage output from the power supply into the first voltage to output;
a receiving circuit, the receiving circuit being coupled with the transmitter via the at least one signal line, and being free from electric power consumption thereof in a case where the at least one signal line is maintained as the reference voltage and in a case where the signal line is maintained at a driving voltage being input; and
a voltage control circuit, the voltage control circuit inputting the first voltage output from the voltage conversion circuit to the receiving circuit as the driving voltage in a case where the transmitter is in the first mode, and inputting the second voltage output from the power supply to the receiving circuit as the driving voltage while stopping an operation of the voltage conversion circuit in a case where the transmitter is in the second mode.
